(19) United States
(12) Patent Application Publication
(10) Pub. No.: US 2025/0306735 A1
(43) Pub. Date: Oct. 2, 2025

(54) INTERFACE INTERACTION METHOD, MEDIUM, AND ELECTRONIC DEVICE

(71) Applicant: Beijing Youzhuju Network Technology Co., Ltd., Beijing (CN)

(72) Inventors: Jinming ZHANG, Beijing (CN); Haoran Li, Beijing (CN); Shengyan SHI, Beijing (CN); Hao YANG, Beijing (CN); Xiaomin SONG, Beijing (CN)

(21) Appl. No.: 19/091,267

(22) Filed: Mar. 26, 2025

(30) Foreign Application Priority Data
Mar. 26, 2024 (CN) 202410355198.9

(51) Int. Cl. G06F 3/0483; G06F 3/0484

(52) U.S. Cl. CPC G06F 3/0483; G06F 3/0484

(57) ABSTRACT

The present disclosure relates to an interface interaction method, a medium, and an electronic device. The method includes: displaying a multimedia resource in a resource display interface, displaying, in a first target region of the resource display interface, an information card associated with the multimedia resource, and in response to a trigger operation for the information card, displaying a target page associated with the information card.

### CROSS-REFERENCE TO RELATED APPLICATION

This application claims the priority to and benefits of the Chinese Patent Application, No. 202410355198.9, which was filed on Mar. 26, 2024. The aforementioned patent application is incorporated herein by reference in its entirety.

### TECHNICAL FIELD

The present disclosure relates to an interface interaction method, a medium, an electronic device and a program product.

### BACKGROUND

With the development of mobile Internet, users are increasingly using mobile terminals to acquire information, especially via videos. In the related art, video description information is often displayed in a video play interface to describe the displayed video. However, the displayed information may include related or unrelated information, which results in the user being unable to pay attention to desired information.

### SUMMARY

This Summary is provided to introduce concepts in a simplified form that are described in detail in the following Detailed Description section. This Summary section is not intended to identify key features or essential features of the claimed technical solution, nor is it intended to be used to limit the scope of the claimed technical solution.

In a first aspect, the present disclosure provides an interface interaction method, including:
displaying a multimedia resource in a resource display interface; and
displaying, in a first target region of the resource display interface, an information card associated with the multimedia resource, where the first target region is a region of the resource display interface for displaying resource description information corresponding to the multimedia resource; and in response to a trigger operation for the information card, displaying a target page associated
with the information card.

In a second aspect, the present disclosure provides an interface interaction apparatus, including:
a first display module, configured to display a multimedia resource in a resource display interface;
a second display module, configured to display, in a first target region of the resource display interface, an information card associated with the multimedia resource, where the first target region is a region of the resource display interface for displaying resource description information corresponding to the multimedia resource; and
a third display module, configured to, in response to a trigger operation for the information card, display a target page associated with the information card.

In a third aspect, the present disclosure provides a computer-readable medium on which a computer program is stored, where steps of the method according to the first aspect are implemented when the program is executed by a processing apparatus.

In a fourth aspect, the present disclosure provides an electronic device, including:
a storage apparatus having a computer program stored thereon; and
a processing apparatus configured to execute the computer program in the storage apparatus to implement the steps of the method according to the first aspect.

In a fifth aspect, the present disclosure provides a computer program product including a computer program, where steps of the method according to the first aspect are implemented when the computer program is executed by a processor.

Other features and advantages of the present disclosure will be described in detail in the following Detailed Description section.

### BRIEF DESCRIPTION OF DRAWINGS

The above and other features, advantages and aspects of various embodiments of the present disclosure will become more apparent with reference to the following detailed description and in conjunction with the drawings. Throughout the drawings, the same or similar reference numerals refer to the same or similar elements. It should be understood that the drawings are schematic and that the components and elements are not necessarily drawn to scale. In the drawings:

FIG. 1 is a flowchart of an interface interaction method according to some embodiments.

FIG. 2 is a schematic diagram of a resource display interface according to some embodiments.

FIG. 3 is a schematic diagram of an information card according to some embodiments.

FIG. 4 is a schematic diagram of a target page according to some embodiments.

FIG. 5 is a flowchart of an interface interaction method according to other embodiments.

FIG. 6 is a schematic diagram of a splash screen interface according to some embodiments.

FIG. 7 is a schematic diagram of a dynamic effect according to some embodiments.

FIG. 8 is a schematic diagram of module connection in an interface interaction apparatus according to some embodiments.

FIG. 9 is a schematic structural diagram of an electronic device according to some embodiments.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. Rather, these embodiments are provided for a thorough and complete understanding of the present disclosure. It should be understood that the drawings and the embodiments of the present disclosure are only for illustrative purposes and are not intended to limit the scope of the present disclosure.

It should be understood that the various steps described in the method implementations of the present disclosure may be performed in different orders and/or in parallel. Furthermore, additional steps may be included and/or the execution of the illustrated steps may be omitted in the method implementations. The scope of the present disclosure is not limited in this respect.

The term “include/include” used herein and the variations thereof are open-ended inclusions, namely, “include/include but not limited to”. The term “based on” is “at least partially based on”. The term “an embodiment” represents “at least one embodiment”; the term “another embodiment” represents “at least one additional embodiment”; and the term “some embodiments” represents “at least some embodiments”. Related definitions of other terms will be given in the following description.

It should be noted that concepts such as “first” and “second” mentioned in the present disclosure are only used to distinguish between different apparatuses, modules or units, and are not used to limit the order of the functions performed by these apparatuses, modules or units or their interdependence.

It should be noted that the modifiers “one” and “a plurality of” mentioned in the present disclosure are illustrative rather than restrictive, and those skilled in the art should understand that unless the context clearly indicates otherwise, they should be understood as “one or more”.

The names of messages or information exchanged by multiple apparatuses in the implementations of the present disclosure are only for illustrative purposes, and are not intended to limit the scope of these messages or information.

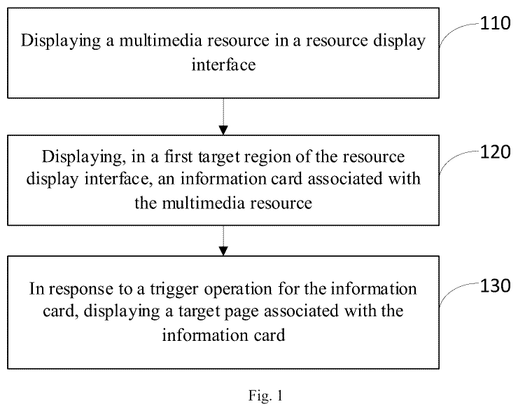

FIG. 1 is a flowchart of an interface interaction method according to some embodiments. As shown in FIG. 1, an embodiment of the present disclosure provides an interface interaction method. The method may be performed by an electronic device, and may specifically be performed by an interface interaction apparatus, which may be implemented in software and/or hardware and configured in the electronic device. As shown in FIG. 1, the method may include the following steps.

In step 110, a multimedia resource is displayed in a resource display interface.

Here, the multimedia resource may be a multimedia resource such as a video, a carousel picture (i.e., a picture group composed of multiple pictures), etc. Of course, the multimedia resource may also be an audio resource. The electronic device may display the multimedia resource through a display page of the multimedia resource.

The resource display interface of the multimedia resource may refer to a display interface in an application for displaying the multimedia resource. Taking a short video application as an example, the resource display interface may be a play interface in the short video program. That is, displaying the multimedia resource in the resource display interface may be understood as the electronic device playing the short video in the play interface of the short video application.

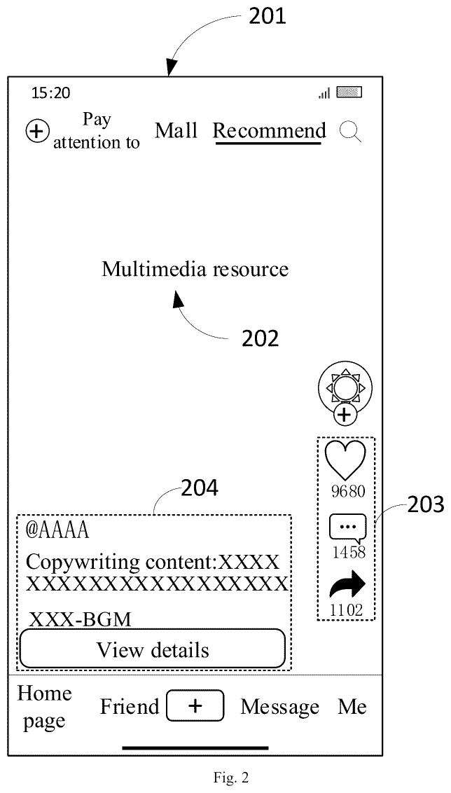

FIG. 2 is a schematic diagram of a resource display interface according to some embodiments. As shown in FIG. 2, the multimedia resource 202 is displayed in the resource display interface 201. It should be understood that the resource display interface 201 may display the multimedia resource 202 through the entire page area or part of the page area of the resource display interface 201. Of course, the resource display interface 201 may further include interface elements. The interface elements may include an interactive control 203, resource description information 204, etc. The interactive control 203 may refer to an element that is used to receive an interactive operation performed by a user on the multimedia resource 202. For example, the interactive control 203 is used to give a like to the multimedia resource 202, to forward the multimedia resource 202, to comment on the multimedia resource 202, and so on. The resource description information 204 may refer to copywriting information (e.g., “copywriting content: XXXXXXXXXXXXXXXXXXXXXXX” in FIG. 2) used to describe the multimedia resource, information (e.g., “@AAAA” in FIG. 2) of an account publishing the multimedia resource, and a corresponding jump button (e.g., a “view details” button in FIG. 2). The information of the publishing account may include an account name of the publishing account and/or an avatar used by the publishing account.

Of course, the resource display interface 201 may also include a control for implementing other functions, such as a control for implementing a video shooting function, a video uploading function, a chatting function, a following function, which will not be described in detail here.

It should be noted that the resource display interface provided in FIG. 2 is used to explain the embodiments of the present disclosure, but it does not mean that the resource display interface can only be as shown in FIG. 2.

In step 120, an information card associated with the multimedia resource is displayed in a first target region of the resource display interface.

Here, the first target region is a region of the resource display interface for displaying the resource description information corresponding to the multimedia resource. As shown in FIG. 2, the first target region is a region where the resource description information 204 is located.

When the multimedia resource is displayed in the resource display interface, the resource description information corresponding to the multimedia resource may be hidden. That is, the resource description information corresponding to the multimedia resource is not displayed in the resource display interface. Of course, whether other page elements (such as the interactive control) of the resource display interface are displayed may be determined according to requirements.

The information card associated with the multimedia resource may be a control capable of interacting with the user, and the information card may be used to provide the user with information related to the multimedia resource.

Exemplarily, the information card may include a target image related to the multimedia resource and/or information related to the multimedia resource. By carrying the target image and/or the information in the information card, the user can be provided with the information related to the multimedia resource by the information card.

The target image included in the information card is associated with the multimedia resource. For example, if the multimedia resource is a game video, the target image may be an image of a game character in a game corresponding to the game video. The information included in the information card may be information related to the multimedia resource. For example, if the multimedia resource is a game video, the information may be related information of the game corresponding to the game video, such as league information. For another example, if the multimedia resource is an advertisement video of a product, the information may be product information of the product in the advertisement video. That is, the information related to the multimedia resource and displayed in the information card may be information configured according to requirements by a provider of the multimedia resource.

It should be noted that the information included in the information card may be the latest information related to the multimedia resource obtained from the Internet. For example, if the multimedia resource is a game video, the information may be a real-time schedule of a league corresponding to the game in the game video.

It should be noted that the information may be displayed in different styles in the information card. For example, the information may be displayed in a style that combines images and texts. Of course, the information may also be displayed in a style of a search box, and the information may also be displayed in a style of a video.

It should be understood that the target image may be a static image or a dynamic image. For example, taking the target image as a game character as an example, the dynamic image may be an image used to display the game character at different angles and/or in different forms. It should be noted that if the target image is a dynamic image, the target image displayed in the information card is dynamically displayed in the process of displaying the target image.

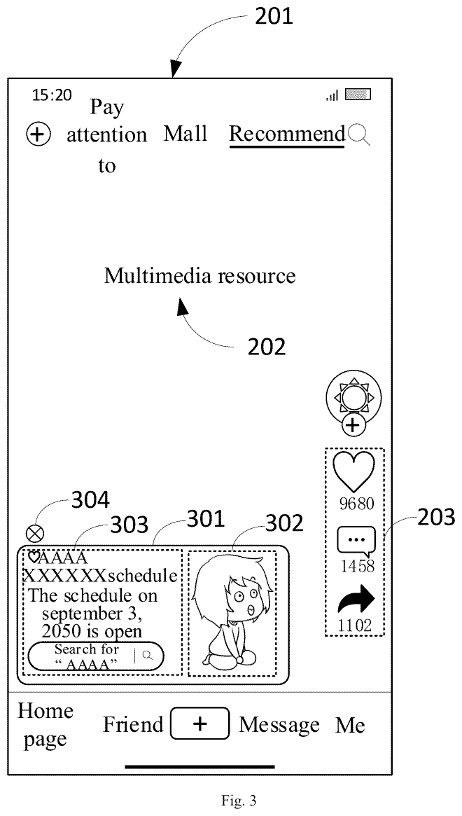

FIG. 3 is a schematic diagram of an information card according to some embodiments. As shown in FIG. 3, the information card 301 may be displayed in the first target region of the resource display interface. The information card 301 includes a target image 302, information 303, and a close control 304 for closing the information card 301.

It should be noted that steps 110 and 120 may be performed synchronously. That is, in this embodiment of the present disclosure, the multimedia resource is displayed through the resource display interface, the information card associated with the multimedia resource is displayed in the first target region of the resource display interface, and the resource description information in the resource display interface is hidden.

It should be noted that displaying the information card in the first target region of the resource display interface may provide the user with the information related to the multimedia resource by means of the information card, so that the user will not miss the information related to the multimedia resource. Moreover, by means of hiding and displaying the resource description information, interference to the user caused by other information in the resource display interface can be reduced, so that the user can pay more attention to the information carried in the information card.

In step 130, in response to a trigger operation for the information card, a target page associated with the information card is displayed.

Here, the trigger operation for the information card may be a click operation. Of course, the trigger operation for the information card may also be other interactive operations, such as a touch-and-hold operation, a voice operation, a gesture operation, and the like, which may be specifically set according to the actual situation. When the electronic device detects the trigger operation for the information card, the electronic device displays the target page associated with the information card.

It should be understood that displaying the target page associated with the information card may be jumping from the resource display interface to the target page. The target page associated with the information card may be set by a developer according to requirements. Of course, in this embodiment of the present disclosure, the target page associated with the information card may be a page associated with the multimedia resource, so that the user can obtain more information related to the multimedia resource through the displayed target page associated with the information card.

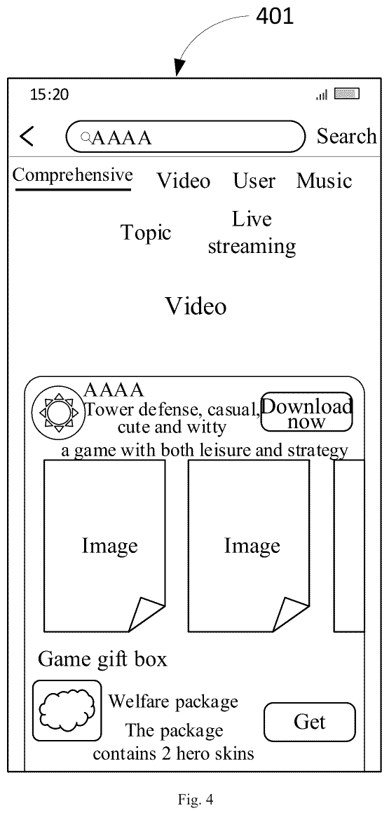

FIG. 4 is a schematic diagram of a target page according to some embodiments. As shown in FIG. 3 and FIG. 4, when the user clicks the information card 301 shown in FIG. 3, the user jumps from the resource display interface 201 to the target page 401, and the target page 401 is a page associated with the information card 301.

Exemplarily, the information card may include a search box and a search word in the search box, and the target page is a page corresponding to the search word in the search box. As shown in FIG. 3, the search word in the search box in the information card 301 is “AAAA”, and as shown in FIG. 4, the target

It should be understood that the search word in the search box may be pre-configured by the developer. In an actual application scene, the search word in the search box may be adjusted by the user, that is, the user may input other search words through the search box to jump to other pages. Of course, the search word in the search box may also be set to be nonadjustable. That is, the search box in the information card does not have a search function, but is a style used to display the search word.

The search word in the search box may form an association between the information card and the target page, and the user may intuitively know the page to which the user will jump after clicking the information card through the search word in the search box.

Therefore, by means of displaying a multimedia resource in a resource display interface, displaying an information card associated with the multimedia resource in a first target region of the resource display interface, and displaying a target page associated with the information card in response to a trigger operation for the information card, the user can be provided with information related to the multimedia resource by the information card, so that the user can pay more attention to the information related to the multimedia resource. Moreover, by means of hiding and displaying resource description information and displaying the information card, interference to the user caused by other information in the resource display interface can be reduced, so that the user can pay more attention to the information carried in the information card, and the information acquisition efficiency of the user is greatly improved.

In some possible implementations, in response to a close operation for the information card, the displaying of the information card may be stopped, and the resource description information corresponding to the multimedia resource may be displayed in the first target region.

Here, the close operation for the information card may be an operation triggered by the user to instruct to close the information card. As shown in FIG. 3, the information card 301 has a close control 304 for closing the information card 301, and the user may trigger the close operation for the information card 301 by clicking the close control 304. In other implementations, the close operation for the information card may be triggered when no operation for the information card is detected after an interval of a preset time period.

In response to the close operation for the information card, the electronic device no longer displays the information card in the first target region of the resource display interface and displays the resource description information corresponding to the multimedia resource in the first target region of the resource display interface.

As shown in FIG. 2 and FIG. 3, when the user clicks the close control 304 in the information card 301 on the resource display interface 201, the resource display interface 201 shown in FIG. 2 is displayed, that is, the resource display interface 201 stops displaying the information card 301 and displays the resource description information 204 corresponding to the multimedia resource 202.

Therefore, through the above implementation, the resource description information corresponding to the multimedia resource can be re-displayed when the user closes the information card, so that the resource description information can be re-displayed when the user does not need the information provided by the information card, so that the user can obtain other information.

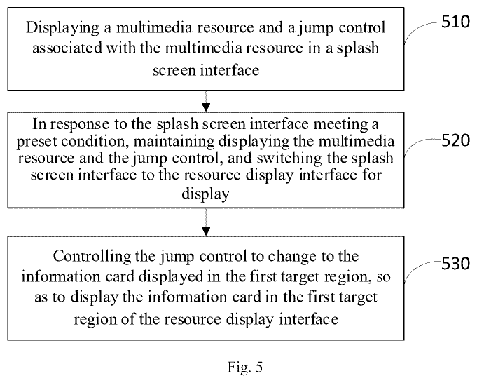

FIG. 5 is a flowchart of an interface interaction method according to other embodiments. As shown in FIG. 5, the interface interaction method may include the following steps.

In step 510, a multimedia resource and a jump control associated with the multimedia resource are displayed in a splash screen interface.

Here, the splash screen interface generally refers to a page displayed after an application is started and before an application page (resource display interface) of the application is displayed. More Internet information, which may include information related or unrelated to the application, may be presented to the user through the splash screen interface.

The multimedia resource and the jump control may be displayed in the splash screen interface. The user may jump to a target page associated with the multimedia resource by clicking the jump control in the splash screen interface.

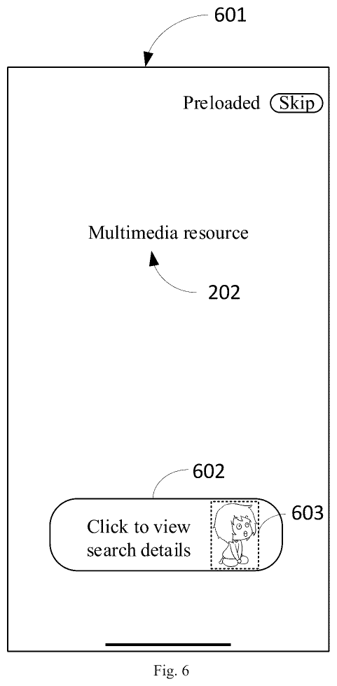

FIG. 6 is a schematic diagram of a splash screen interface according to some embodiments. As shown in FIG. 6, the multimedia resource 202 and the jump control 602 are displayed in the splash screen interface 601. It should be understood that if the user clicks the jump control 602, the target page 401 shown in FIG. 4 may be displayed.

In some embodiments, the jump control includes a target image related to the multimedia resource. As shown in FIG. 6, the jump control 602 includes a target image 603.

The target image may be a static image or a dynamic image. For example, taking the target image as a game character as an example, the dynamic image may be an image used to display the game character at different angles and/or in different forms. It should be noted that if the target image is a dynamic image, the target image displayed in the information card is dynamically displayed in the process of displaying the target image.

It should be noted that the jump control of the splash screen interface and the information card displayed in the resource display interface may include the same target image. Through the same target image, the splash screen interface and the resource display interface can be connected in series visually, and the association between the splash screen interface and the resource display interface is enhanced, thereby enhancing the user's immersion and enabling the user to pay attention to the related information displayed in the information card in time.

In step 520, in response to the splash screen interface meeting a preset condition, displaying of the multimedia resource and the jump control is maintained, and the splash screen interface is switched to the resource display interface for display.

Here, that the splash screen interface meets the preset condition may refer to that a display duration of the splash screen interface reaches a preset duration. For example, the preset duration may be 3 seconds, and after the splash screen interface is displayed for 3 seconds and no other operation for the splash screen interface is detected, in response to meeting the preset condition, displaying of the multimedia resource and the jump control is maintained, and the splash screen interface is switched to the resource display interface for display. It should be noted that the preset duration may be set according to actual requirements.

It should be noted that the multimedia resource is displayed through a first video layer, the splash screen interface and the resource display interface are displayed through an interface layer, and the information card and the jump control are displayed through a second video layer. The interface layer is superimposed on an upper layer of the first video layer, and the second video layer is superimposed on an upper layer of the interface layer.

The multimedia resource is displayed in the first video layer, the splash screen interface is displayed in the interface layer superimposed on the upper layer of the first video layer, and the jump control is displayed in the second video layer superimposed on the upper layer of the interface layer. When the splash screen interface meets the preset condition, the first video layer maintains displaying the multimedia resource and the second video layer maintains displaying the jump control, and the interface layer switches the displayed splash screen interface to the resource display interface for display.

It should be understood that maintaining displaying the multimedia resource may refer to continuing to display the multimedia resource according to the original progress. Taking the multimedia resource as a video as an example, in the process of switching the splash screen interface to the resource display interface for display, the video is still played according to the original video progress, and the content of the video will not be interrupted.

In step 530, the jump control is controlled to change to the information card displayed in the first target region so that the information card is displayed in the first target region of the resource display interface.

Here, the jump control changing to the information card displayed in the first target region may refer to that the information card displayed in the first target region is obtained by changing the jump control. Exemplarily, the jump control may be scaled and displayed as the information card, and corresponding information may be displayed on the information card.

It should be noted that when the jump control changes to the information card, the target image in the jump control may be maintained to be displayed. That is, the target image in the information card may be the target image in the jump control, thereby creating an atmosphere that the information card is evolved from the jump control visually.

It should be noted that the jump control may be controlled to change to the information card displayed in the first target region in the process of switching the splash screen interface to the resource display interface for display. That is, in the process of switching the splash screen interface in the interface layer to the resource display interface, the jump control in the second video layer also gradually changes to the information card.

As shown in FIG. 6 and FIG. 3, the jump control 602 in FIG. 6 is transformed and displayed as the information card 301 shown in FIG. 3.

Therefore, through the above steps 510 and 530, the splash screen interface and the resource display interface can form an association visually, thereby connecting the information displayed in the splash screen interface with the information displayed in the resource display interface in series, so that the user can pay attention to the information displayed in the information card when switching from the splash screen page to the resource display interface, so as to avoid the information in the information card from being missed.

In some possible implementations, in step 130, in response to the trigger operation for the information card, the target page associated with the information card may be displayed, and the target image may be moved from the information card to the second target region of the target page.

Here, when it is detected that the user clicks the information card in the resource display interface, the target page associated with the information card is displayed, and the target image displayed on the information card is moved from the information card to the second target region of the target page. That is, when the resource display interface is switched to the target page, the target image displayed on the information card in the resource display interface is moved from the information card to the second target region of the target page.

In some embodiments, the target image related to the multimedia resource may be an image element in the target page. Correspondingly, the second target region of the target page may be the position of the image element in the target page.

It should be understood that by means of moving the target image from the information card to the second target region of the target page, the resource display interface and the target page can form an association visually, thereby connecting the splash screen interface, the resource display interface and the target page in series visually, thereby enhancing the user's immersion in the page.

In some embodiments, a dynamic effect corresponding to the target image may be displayed, and in response to the dynamic effect being displayed to a preset node, the target page associated with the information card may be displayed, where the dynamic effect is used to describe that the target image is away from the information card and gradually moves to the second target region of the target page.

Here, when it is detected that the user clicks the information card in the resource display interface, the dynamic effect corresponding to the target image may be displayed in the resource display interface. When the dynamic effect is displayed to the preset node, the resource display interface is switched to the target page associated with the information card for display. In the process of switching the resource display interface to the target page, the target image is controlled to gradually move to the second target region of the target page and finally stay in the second target region of the target page.

The dynamic effect corresponding to the target image may be a video corresponding to the target image. Taking the target image as a game character as an example, the dynamic effect of the game character may be a video used to display the game character at different angles and/or in different forms.

Exemplarily, the multimedia resource is displayed in the first video layer, the resource display interface is displayed in the interface layer superimposed on the upper layer of the first video layer, and the information card is displayed in the second video layer superimposed on the upper layer of the interface layer. When the user clicks the information card, the dynamic effect corresponding to the target image is displayed through the second video layer, and the dynamic effect describes that the target image is away from the information card and gradually moves to the second target region of the target page. When the dynamic effect is displayed to the preset node, the first video layer and the interface layer are switched to the target page associated with the information card for display.

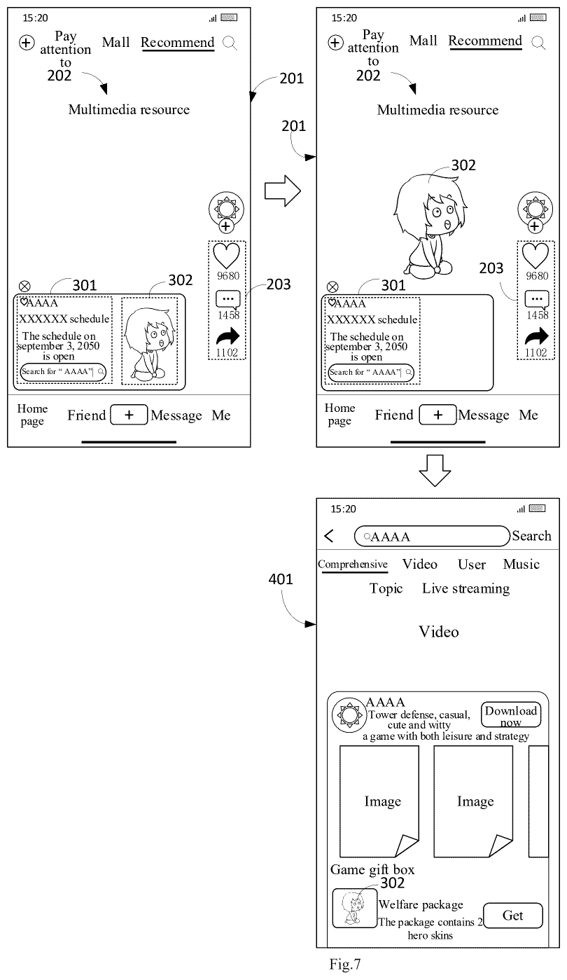

FIG. 7 is a schematic diagram of a dynamic effect according to some embodiments. As shown in FIG. 7, the target image 301 in the information card 301 is gradually away from the information card 301, and in the process of being away from the information card 301, the target image 301 is gradually enlarged and displayed. After the target image 301 moves to the third target region of the resource display interface 201, the target page 401 is displayed, and the target image 301 is controlled to gradually move to the second target region of the target page 401. Moreover, in the process of the target image 301 gradually moving to the second target region of the target page 401, the target image 301 may be gradually reduced and finally stay in the second target region.

Therefore, by means of moving the target image from the information card to the second target region of the target page, the resource display interface and the target page can form an association visually, thereby connecting the splash screen interface, the resource display interface and the target page in series visually, thereby enhancing the user's immersion in the page.

FIG. 8 is a schematic diagram of module connection in an interface interaction apparatus according to some embodiments. As shown in FIG. 8, an embodiment of the present disclosure provides an interface interaction apparatus 800, and the interface interaction apparatus 800 includes:
a first display module 801, configured to display a multimedia resource in a resource display interface;
a second display module 802, configured to display, in a first target region of the resource display interface, an information card associated with the multimedia resource, where the first target region is a region of the resource display interface for displaying resource description information corresponding to the multimedia resource; and
a third display module 803, configured to, in response to a trigger operation for the information card, display a target page associated with the information card.

Optionally, the interface interaction apparatus 800 further includes:
a fourth display module, configured to, in response to a close operation for the information card, stop displaying the information card and display the resource description information corresponding to the multimedia resource in the first target region.

Optionally, the first display module 801 includes:
a first display unit, configured to display the multimedia resource and a jump control associated with the multimedia resource in a splash screen interface; and
a second display unit, configured to, in response to the splash screen interface meeting a preset condition, maintain displaying the multimedia resource and the jump control, and switch the splash screen interface to the resource display interface for display; and
the second display module 802 is specifically configured to:
control the jump control to change to the information card displayed in the first target region, so as to display the information card in the first target region of the resource display interface.

Optionally, the jump control includes a target image related to the multimedia resource, and the information card includes the target image and/or information related to the multimedia resource.

Optionally, the target image is a static image or a dynamic image, the information card includes a search box and a search word in the search box, and the target page is a page corresponding to the search word.

Optionally, the information card includes a target image related to the multimedia resource; and the third display module 803 is specifically configured to:
in response to the trigger operation for the information card, display the target page associated with the information card, and move the target image from the information card to a second target region of the target page.

Optionally, the third display module 803 is specifically configured to:
display a dynamic effect corresponding to the target image, and in response to the dynamic effect being displayed to a preset node, display the target page associated with the information card, where the dynamic effect is used to describe that the target image is away from the information card and gradually moves to the second target region of the target page.

For the logic of the method performed by the various functional modules in the above interface interaction apparatus 800, reference may be made to the part of the method related to the above embodiments, which will not be repeated here.

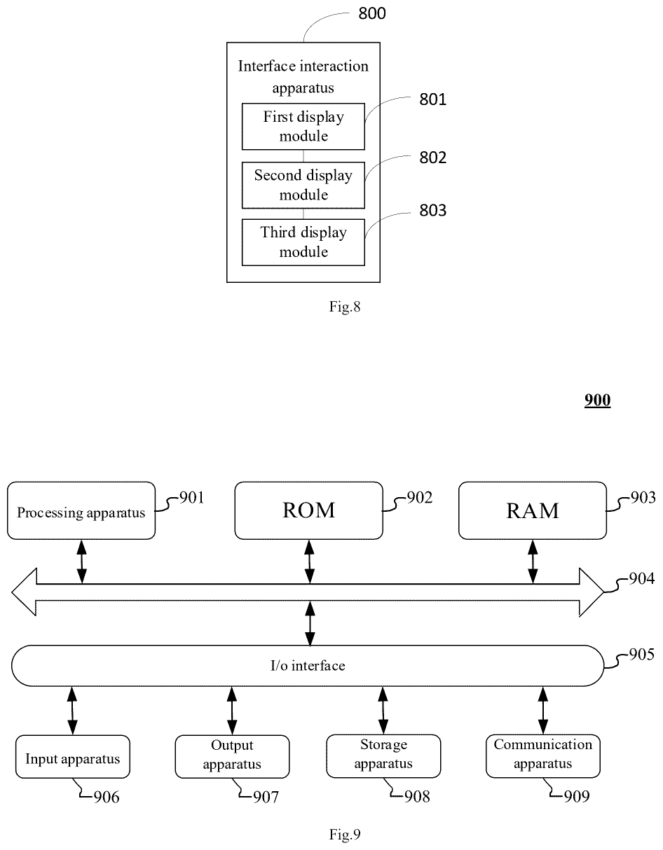

Reference is made to FIG. 9 below, which illustrates a schematic structural diagram of an electronic device (for example, a terminal device) 900 suitable for implementing the embodiments of the present disclosure. The terminal device in the embodiments of the present disclosure may include, but is not limited to, a mobile terminal such as a mobile phone, a laptop, a digital broadcast receiver, a PDA (Personal Digital Assistant), a PAD (tablet computer), a PMP (Portable Multimedia Player), a vehicle-mounted terminal (for example, a vehicle-mounted navigation terminal), etc., and a fixed terminal such as a digital TV, a desktop computer, etc. The electronic device shown in FIG. 9 is only an example, and should not bring any limitation to the functions and scope of use of the embodiments of the present disclosure.

As shown in FIG. 9, the electronic device 900 may include a processing apparatus (e.g., a central processing unit, a graphics processing unit, etc.) 901, which may perform various appropriate actions and processes according to a program stored in a read-only memory (ROM) 902 or a program loaded from a storage apparatus 908 into a random-access memory (RAM) 903. Various programs and data required for the operation of the electronic device 900 are also stored in the RAM 903. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, a gyroscope, etc.; an output apparatus 907 including, for example, a liquid crystal display (LCD), a speaker, a vibrator, etc.; the storage apparatus 908 including, for example, a magnetic tape, a hard disk, etc.; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the illustrated apparatuses. It may be an alternative to implement or have more or fewer apparatuses.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program code for executing the method shown in the flowchart. In such an embodiment, the computer program may be downloaded and installed from a network through the communication apparatus 909, or installed from the storage apparatus 908, or installed from the ROM 902. When the computer program is executed by the processing apparatus 901, the above-mentioned functions defined in the method of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection having one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in a baseband or as a part of a carrier, in which a computer-readable program code is carried. The propagated data signal may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus or device. The program code contained on the computer-readable medium may be transmitted by any suitable medium, including but not limited to: a wire, an optical cable, RF (radio frequency), etc., or any suitable combination thereof.

In some implementations, the electronic device may communicate using any currently known or future-developed network protocol, such as HTTP (HyperText Transfer Protocol), and may be interconnected with digital data communication (for example, a communication network) in any form or medium. Examples of the communication network include a local area network (“LAN”), a wide area network (“WAN”), an internetwork (for example, the Internet), and a peer-to-peer network (for example, an ad hoc peer-to-peer network), as well as any currently known or future-developed network.

The above computer-readable medium may be included in the above electronic device, or may exist alone without being assembled into the electronic device.

The above computer-readable medium carries one or more programs, and when the one or more programs are executed by the electronic device, the electronic device is caused to: display the multimedia resource in the resource display interface; display the information card associated with the multimedia resource in the first target region of the resource display interface, where the first target region is the region of the resource display interface for displaying the resource description information corresponding to the multimedia resource; and display the target page associated with the information card in response to the trigger operation for the information card.

The computer program code for performing the operations of the present disclosure may be written in one or more programming languages or a combination thereof, including but not limited to an object-oriented programming language such as Java, Smalltalk, C++, and a conventional procedural programming language such as “C” language or similar programming languages. The program code may be executed entirely on a user computer, partly on a user computer, as a stand-alone software package, partly on a user computer and partly on a remote computer, or entirely on a remote computer or a server. In the case of a remote computer, the remote computer may be connected to the user computer through any kind of network, including a local area network (LAN) or a wide area network (WAN), or may be connected to an external computer (for example, through the Internet provided by an Internet service provider).

The flowcharts and block diagrams in the drawings illustrate the architecture, functionality, and operation of possible implementations of systems, methods, and computer program products in accordance with various embodiments of the present disclosure. In this regard, each block in a flowchart or block diagram may represent a module, a program segment, or a portion of code, which includes one or more executable instructions for implementing specified logic functions. It should also be noted that in some alternative implementations, the functions indicated in the blocks may also occur in a different order than the order indicated in the drawings. For example, two blocks shown in succession may actually be executed substantially in parallel, or sometimes in a reverse order, depending on the functions involved. It should also be noted that each block in the block diagrams and/or flowcharts, and a combination of blocks in the block diagrams and/or flowcharts, may be implemented by a dedicated hardware-based system that performs specified functions or operations, or may be implemented by a combination of dedicated hardware and computer instructions.

The modules involved in the embodiments of the present disclosure may be implemented in software or hardware. The name of a module does not constitute a limitation on the module itself under certain circumstances.

The functions described herein above may be performed at least in part by one or more hardware logic components. For example, without limitation, example types of hardware logic components that may be used include: a field programmable gate array (FPGA), an application specific integrated circuit (ASIC), an application specific standard product (ASSP), a system on chip (SOC), a complex programmable logic device (CPLD), and so on.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

The above description is merely an illustration of the preferred embodiments of the present disclosure and the applied technical principles. Those skilled in the art should understand that the scope of disclosure involved in the present disclosure is not limited to the technical solutions formed by the specific combination of the above-mentioned technical features, but also covers other technical solutions formed by any combination of the above-mentioned technical features or their equivalents without departing from the above-mentioned disclosed concept. For example, a technical solution formed by replacing the above-mentioned features with the technical features having similar functions disclosed in the present disclosure (but not limited to).

In addition, although the operations are depicted in a specific order, this should not be understood as requiring these operations to be performed in the specific order shown or in a sequential order. Under certain circumstances, multitasking and parallel processing may be advantageous. Likewise, although several specific implementation details are included in the above discussion, these should not be construed as limiting the scope of the present disclosure. Certain features described in the context of separate embodiments may also be implemented in combination in a single embodiment. On the contrary, various features described in the context of a single embodiment may also be implemented in multiple embodiments separately or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms for implementing the claims. Regarding the apparatus in the above-mentioned embodiments, the specific manner in which each module performs operations has been described in detail in the embodiments related to the method, which will not be described in detail here.

1. An interface interaction method, comprising:
displaying a multimedia resource in a resource display interface;
displaying, in a first target region of the resource display interface, an information card associated with the multimedia resource, wherein the first target region is a region of the resource display interface for displaying resource description information corresponding to the multimedia resource; and
in response to a trigger operation for the information card, displaying a target page associated with the information card.

2. The method according to claim 1, further comprising:
in response to a close operation for the information card, stopping displaying the information card and displaying the resource description information corresponding to the multimedia resource in the first target region.

3. The method according to claim 1, wherein the displaying a multimedia resource in a resource display interface comprises:
displaying the multimedia resource and a jump control associated with the multimedia resource in a splash screen interface;
in response to the splash screen interface meeting a preset condition, maintaining displaying the multimedia resource and the jump control, and switching the splash screen interface to the resource display interface for display; and
the displaying, in a first target region of the resource display interface, an information card associated with the multimedia resource comprises:
controlling the jump control to change to the information card displayed in the first target region, so as to display the information card in the first target region of the resource display interface.

4. The method according to claim 3, wherein the jump control comprises a target image related to the multimedia resource, and the information card comprises the target image and/or information related to the multimedia resource.

5. The method according to claim 4, wherein the target image is a static image or a dynamic image, the information card comprises a search box and a search word in the search box, and the target page is a page corresponding to the search word.

6. The method according to claim 1, wherein the information card comprises a target image related to the multimedia resource; the in response to a trigger operation for the information card, displaying a target page associated with the information card comprises:
in response to the trigger operation for the information card, displaying the target page associated with the information card, and moving the target image from the information card to a second target region of the target page.

7. The method according to claim 6, wherein the displaying the target page associated with the information card, and moving the target image from the information card to a second target region of the target page comprises:
displaying a dynamic effect corresponding to the target image, and in response to the dynamic effect being displayed to a preset node, displaying the target page associated with the information card, wherein the dynamic effect is used to describe that the target image is away from the information card and gradually moves to the second target region of the target page.

8. A non-transitory computer-readable medium, on which a computer program is stored, wherein steps of an interface interaction method are implemented when the program is executed by a processing apparatus, and the method comprises:
displaying a multimedia resource in a resource display interface;
displaying, in a first target region of the resource display interface, an information card associated with the multimedia resource, wherein the first target region is a region of the resource display interface for displaying resource description information corresponding to the multimedia resource; and
in response to a trigger operation for the information card, displaying a target page associated with the information card.

9. An electronic device, comprising:
a storage apparatus, on which a computer program is stored; and
a processing apparatus, configured to execute the computer program in the storage apparatus to implement steps of an interface interaction method, and the method comprises:
displaying a multimedia resource in a resource display interface;
displaying, in a first target region of the resource display interface, an information card associated with the multimedia resource, wherein the first target region is a region of the resource display interface for displaying resource description information corresponding to the multimedia resource; and
in response to a trigger operation for the information card, displaying a target page associated with the information card.

10. The electronic device according to claim 9, wherein the method further comprises:
in response to a close operation for the information card, stopping displaying the information card and displaying the resource description information corresponding to the multimedia resource in the first target region.

11. The electronic device according to claim 9, wherein the displaying a multimedia resource in a resource display interface comprises:
displaying the multimedia resource and a jump control associated with the multimedia resource in a splash screen interface;
in response to the splash screen interface meeting a preset condition, maintaining displaying the multimedia resource and the jump control, and switching the splash screen interface to the resource display interface for display; and
the displaying, in a first target region of the resource display interface, an information card associated with the multimedia resource comprises:
controlling the jump control to change to the information card displayed in the first target region, so as to display the information card in the first target region of the resource display interface.

12. The electronic device according to claim 11, wherein the jump control comprises a target image related to the multimedia resource, and the information card comprises the target image and/or information related to the multimedia resource.

13. The electronic device according to claim 12, wherein the target image is a static image or a dynamic image, the information card comprises a search box and a search word in the search box, and the target page is a page corresponding to the search word.

14. The electronic device according to claim 9, wherein the information card comprises a target image related to the multimedia resource; the in response to a trigger operation for the information card, displaying a target page associated with the information card comprises:
in response to the trigger operation for the information card, displaying the target page associated with the information card, and moving the target image from the information card to a second target region of the target page.

15. The electronic device according to claim 14, wherein the displaying the target page associated with the information card, and moving the target image from the information card to a second target region of the target page comprises:
displaying a dynamic effect corresponding to the target image, and in response to the dynamic effect being displayed to a preset node, displaying the target page associated with the information card, wherein the dynamic effect is used to describe that the target image is away from the information card and gradually moves to the second target region of the target page.
